(19) United States
(12) Patent Application Publication
(10) Pub. No.: US 2003/0015362 A1
(43) Pub. Date: Jan. 23, 2003

(54) Closure for hydraulic hose grommet opening

(76) Inventors: Jason J. Asche, Bismarck, ND (US); William H. Curl, Bismarck, ND (US); Hector Matthys, Cottonwood, MI (US)

Correspondence Address: Nickolas E. Westman, WESTMAN CHAMPLIN & KELLY, International Centre, Suite 1600, 900 South Second Avenue, Minneapolis, MN, 55402-3319, US

(21) Appl. No.: 09/908,276

(22) Filed: Jul. 18, 2001

(51) Int. Cl. B62D 33/06

(52) U.S. Cl. 180/89.12

(57) ABSTRACT

A dividing wall between an engine compartment and an operator's compartment of an excavator is provided with an opening through which lines or tubes, such as hydraulic lines or air conditioning lines must pass. The lines or tubes have fittings at their ends which are larger than the lines or tubes, so that the opening, which is in center portions of the wall, has to be large enough to permit passage of the fittings through the wall. The tubes, which are smaller, thus leave portions of the opening uncovered when they are in place. The opening has a number of recesses along one edge that are of size to receive first portions of grommets that in turn surround the tubes. A seal plate that has mating recesses that receive other portions of the grommets extending into the opening is placed to cover the opening, support the grommets, and seal the opening to reduce the passage of heat, noise and the like through the wall when in place.

### BACKGROUND OF THE INVENTION

The present invention relates to a seal or closure plate for covering an opening in a wall through which hydraulic hoses and/or lines pass. The hoses or lines that at the opening has to be large enough to accommodate fittings that are larger in cross section than the hoses or lines themselves. A plate is used for supporting grommets around the lines and closing the opening for the lines to reduce the transmission of noise and heat, for example, from an engine compartment into an operator's cab.

Various split grommets for surrounding and sealing hoses have been used in the past. In most instances, the openings for such grommets are accessible from an edge of a plate or wall so that the openings are not enclosed, but are open ended slots. The access to such slot openings for grommets either has to be sealed with the grommet itself, or placed adjacent an edge of a plate so that the slot can be made from the edge to the opening.

In large panels, such as the fire wall or dividing wall between an engine compartment and an operator's compartment on an excavator, it is many times necessary to run hydraulic hoses, or tubes, through center portions of the dividing wall so that accessing these openings from slots leading from an edge of the wall is substantially impossible. The slot length to permit sliding tubes into the center portion of the walls, would be excessive and would need covers for both sealing and to restore strength to the wall.

It is thus necessary to have a large enough opening in the wall to permit fittings to pass through freely, and then, the hoses or lines, which are smaller than the fittings themselves, are left with a clearance hole around them, through which heat, noise, and dirt can pass. Merely wrapping the hoses in grommets is not satisfactory, because the hole has to be large enough so that using foam material or similar materials does not work well.

The lines are also subjected to some vibration and, particularly when metal tubes are used as the hydraulic lines they should be supported to prevent damage to the tubes. The tubes need some structural support or they will rattle and move and cause abrasion and perhaps damages to the lines. These lines also need protection from the sharp edges of the passage opening or hole.

It is desirable to have a large opening for ease of threading the hoses or lines through the opening in the wall, particularly during assembly.

### SUMMARY OF THE INVENTION

The present invention relates to a rigid support and closure plate used over a large opening in a wall of a vehicle cab body, through which one or more fluid carrying lines, either hoses or metal tubes (called liner collectively), must pass and which plate will support grommets surrounding the lines when installed and will provide a closure plate for the large opening needed. The rigid plate supports the hydraulic lines in position.

The wall through which the lines extend has an opening that is large enough to accommodate the end fittings of hydraulic or other fluid carrying lines, which must pass through a wall such as the fire wall or separating wall between an engine compartment and an operator's cab on an excavator or skid steer loader. The opening has substantial size for ease of passing the lines into positioning even if three are formed bends in the lines. One edge of the large opening has part cylindrical recesses to receive split grommets that will surround the lines. The lines rest in these part cylindrical recesses so they are held in a known location relative to each other and relative to the wall. Then, a rigid plate that has part cylindrical recesses on one edge thereof that mate with and overlie the recesses in the edge of the opening will receive portions of the same grommets to support the lines. The plate is of size to cover the opening and is put into place and is secured against the wall surfaces surrounding the opening to close the opening.

The plate rigidly and securely supports the hydraulic lines through the grommets surrounding the lines. The large opening is thus closed, so that noise, heat and dirt cannot be transmitted through the opening. The plate is generally of metal, so that it is rigid and holds the lines securely.

### BRIEF DESCRIPTION OF THE DRAWINGS

FIG. 1 is a schematic representation of an excavator having an engine compartment and cab, and including the seal plate of the present invention for supporting hydraulic lines;

FIG. 2 is a perspective view of a portion of the engine dividing wall of the excavator, showing the seal plate, grommets, and schematically illustrating one hydraulic line in position;

FIG. 3 is a sectional view illustrating a single grommet in position on the seal plate and a portion of the fire wall;

FIG. 4 is a fragmentary front view of a portion of the engine wall as viewed from the cab side; and

FIG. 5 is a fragmentary front view of the cover plate.

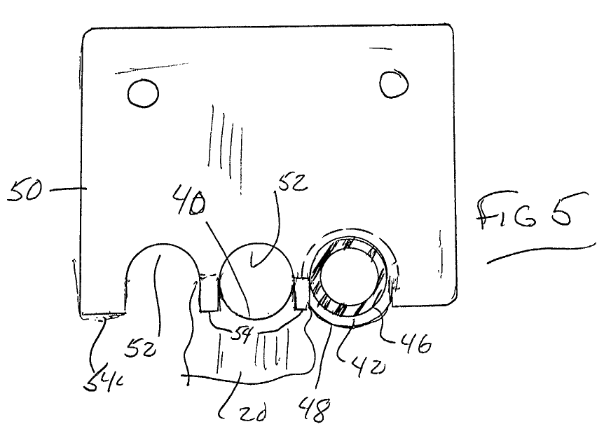

### DETAILED DESCRIPTION OF THE PREFERRED EMBODIMENTS

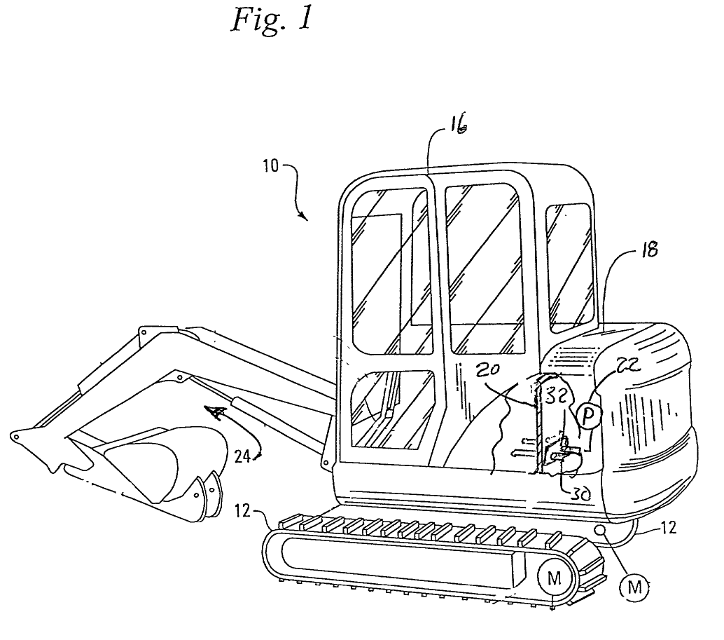

As shown in FIG. 1, an excavator 10 includes a frame 12, and tracks that are provided for drive and steering functions. An operator's cab 16 is positioned ahead of an engine compartment 18, which is at the rear. A dividing wall indicated generally at 20 separates the rear side of the cab 16 from the engine compartment 18. It is desirable that this wall remain solid, or imperforate, so heat that is generated by the engine, and also noise and dirt or debris will not pass easily through the wall into the operator's compartment 16. Reducing noise transmission minimizes operator fatigue and discomfort. There is a need for carrying hydraulic lines or hoses through the wall 20 from a hydraulic pump illustrated generally at 22 to power various functions on the excavator, such as hydraulic actuates for operating the boom and bucket 24 of the loader.

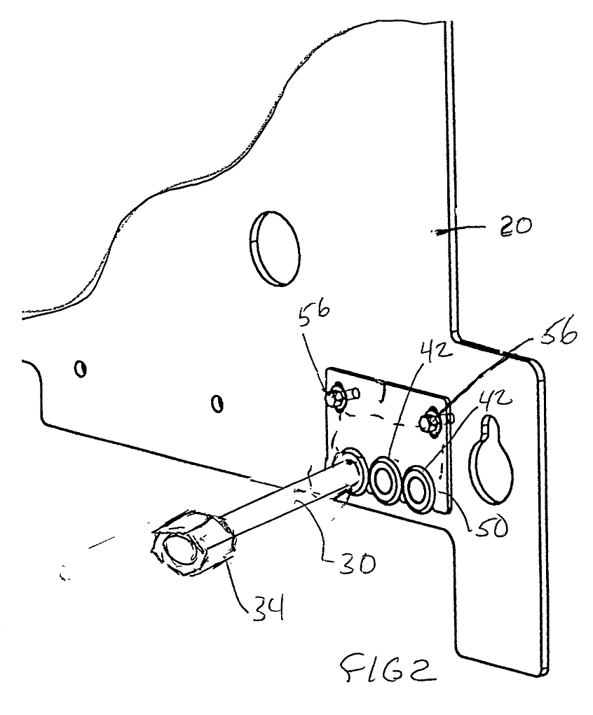

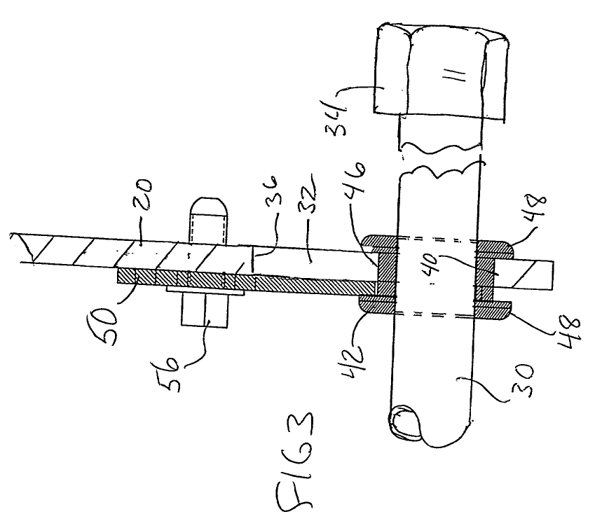

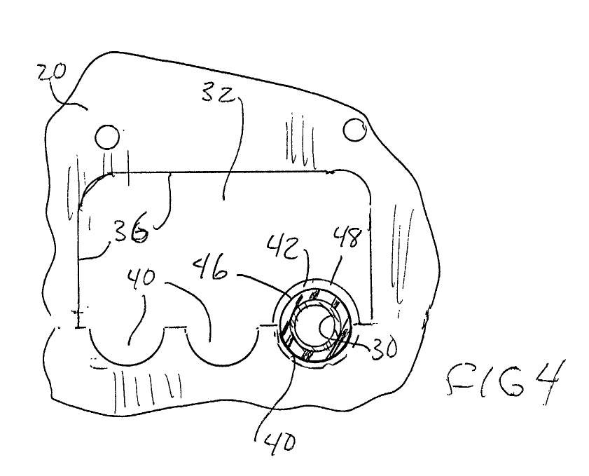

As shown in FIG. 2, fluid carrying lines 30 can either be hoses, or metal tubes that will pass through an opening shown in FIGS. 3 and 4 at 32 that is large enough to accommodate the fittings at the ends of the lines that are illustrated only schematically at 34 in FIG. 2. The lines can be for hydraulic fluid, air conditioning conducts or other lines needed. This opening also is made so that the lines can easily be passed through the wall 20 during assembly of the excavator. The tubes must be supported adequately so that they will not rattle or vibrate excessively, and they will be protected from the edges 36 of the large opening, which can be sharp or have burrs from forming.

The lower edge of the opening 32 is provided with a selected number of semi-circular or semi-cylindrical recesses indicated generally 40. The number of the semi-cylindrical recesses 40 can be varied, depending on the number of lines that must be carried through the wall 20. These semi-cylindrical or semi-circular recesses 40 are of diameter to receive and support grommets 42 to protect the lines from 30 the edges of the recesses 40. The grommets 42 are conventional split grommets, and have a peripheral surface 46 that is positioned between larger diameter grommet side flanges 48, that fit on opposite sides of the semi-cylindrical recesses 40.

The opening 32, as can be seen, has a substantial central area indicated generally at 48 that would permit heat, noise, dirt and debris, to pass through, but in order to do that, a seal plate 50 is made larger than the opening 32, and it to has semi-cylindrical recesses in its bottom edge indicated at 52. These semi-cylindrical recesses are spaced the same as the recesses 40, and are of size to receive the cylindrical peripheral surface 46 of the grommets. The lower edge 54 of plate 50 extends down sufficiently so that it overlaps the lower edges 56 of the opening 32, in the regions between the semi-cylindrical or semi-circular recesses 40. Thus, the seal plate 50 will rest against the surface of the wall 20, at the lower edge of the opening 32, and it extends upwardly and sideways sufficiently so that it also overlaps the upper edge of opening 32 and rests against wall 20 at the periphery of opening 32 as shown.

The overlap of plate 50 above the upper edge of the opening 32 is enough so the seal plate 50 can be fastened in place with threaded screws 56 that fasten the seal plate securely against the wall 20. The part cylindrical recesses 52 overlie the grommets and hold the grommets securely. The plate will hold the hydraulic lines or tubes 30 securely, and the lines are held in assembly with the opening 32 completely sealed to prevent noise, heat and debris from passing through. The seal plate 50 is a rigid plate that provides support, and is imperforate, to ensure that there is no opening of substantial size to permit heat and noise to pass through the divider wall.

The operator in the cab 16 of the excavator 10 is not subjected to excessive noise and vibration merely because of an opening that must accommodate the end fittings of hydraulic hoses, or air conditioning lines that have fittings and which must pass from the rear engine compartment 18 to a cab or operator compartment 16 of an excavator.

The split grommets can separable so that they can be placed over the tubes or lines, and then the tubes or lines passed through the openings, the grommets seated in the recesses 40, and then the seal plate 50 can be applied with the recesses 52 overlying the upper portions of the grommets and with the bottom portions of the seal plate resting against the wall 20. The seal plate 50 is securely fastened to wall 20, as shown with cap screws, but rivets, pop rivets, self-tapping screws or various adhesives can be used as fasteners.

Although the present invention has been described with reference to preferred embodiments, workers skilled in the art will recognize that changes may be made in form and detail without departing from the spirit and scope of the invention.

What is claimed is:

1. A seal plate for closing an opening in a wall through which tubes or lines having end fittings larger than the tubes or lines pass, the opening being large enough to permit passage of the fittings, the opening being configured to have recesses along one edge thereof of size to receive and support first portions of grommets surrounding the tubes or lines, the seal plate being an imperforate rigid plate having recesses along one edge that will receive selected portions of the grommets which protrude into the opening, and which seal plates is of size to completely cover the opening and is adapted to rest against a surface of the wall.

2. The seal plate of claim 1, wherein said seal plate is secured to the wall with fasteners.

3. The seal plate of claim 1, wherein said seal plate has a periphery that is larger than the periphery of the opening.

4. The seal plate of claim 1, wherein said recesses are part cylindrical to receive peripheral portions of substantially cylindrical periphery grommets, and said recesses being accessible from center portions of the opening.

5. The seal plate of claim 4, wherein said recesses in the seal plate are recessed inwardly from the one edge sufficiently so that portions of the one edge of the seal plate overlap the one edge of the opening in the walls.

6. The seal plate of claim 1, wherein said seal plate is a metal plate.

7. The seal plate of claim 1, wherein said wall is a divider wall between an engine compartment and an operator's compartment of a vehicle.

8. The seal plate of claim 1, wherein said wall is a divider wall between an engine compartment and an operator's compartment of an excavator.

9. The seal plate of claim 5 wherein the opening and the seal plate are both generally rectangular.

10. In combination, a divider wall between an engine compartment and an operator's cab, the wall having an opening through lines having fittings larger than the lines, which the lines end being unsupported on a resilient grommet encircling the line and having a cylindrical surface, a plurality of recesses formed along one edge of the opening to receive and seal on first portions of the grommets, and a seal plate larger than the opening and having recess on one edge thereof to receive other portions of the grommets so the grommets are held by the recessed when the seal plate is fastened to the wall to cover the opening.

11. The combination of claim 10 wherein the seal plate is imperforate.

12. The combination of claim 10 wherein the seal plate overlaps the opening on all sides of the opening and is secured to wall surfaces surrounding the opening.

13. The combination of claim 10 wherein the opening is spaced inwardly from peripheral edges of the wall.

14. The combination of claim 13 wherein the opening is rectangular.
